(19) United States
(12) Patent Application Publication
(10) Pub. No.: US 2026/0368907 A1
(43) Pub. Date: Nov. 19, 2026

(54) Privacy-Preserving Tracking

(71) Applicant: Google LLC, Mountain View, CA (US)

(72) Inventor: Aditya Shailesh Ghadiali, San Jose, CA (US)

(21) Appl. No.: 19/515,682

(22) PCT Filed: Sep. 1, 2023
(86) PCT No.: PCT/US2023/031828

§ 371 Date: Mar. 2, 2026

(51) Int. Cl. G06T 7/20; G06T 7/73; G06V 40/20; H04N 23/11

(52) U.S. Cl. CPC G06T 7/20; G06T 7/73; G06V 40/28; H04N 23/11; G06T 2207/30241; G06V 2201/07

(57) ABSTRACT

Features described herein pertain to privacy-preserving tracking. Depth information derived from depth data generated by a sensor that includes photodiodes having a field-of-view within a portion of an environment surrounding an electronic device can be used to recognize a gesture performed by at least one person within the field-of-view and the electronic device can be controlled based on the gesture. The environment surrounding the electronic device can be illuminated with infrared light in which a portion of the infrared light reflected from an object in a field-of-view of the sensor can be captured by the sensor. A center of gravity of the object can be tracked captured light and a notification can be generated based on the tracked center of gravity.

### BACKGROUND

Motion detection and tracking technologies have become an integral part of electronic devices. Such technologies can facilitate human-computer interaction. For example, using these technologies, electronic devices can be controlled using gestures and can assist users in performing their daily activities. Electronic devices that detect people and track motion are often used in locations where privacy is expected such as in a home. As such, electronic devices incorporating these technologies can lead to privacy concerns. Therefore, it may be desirable to provide privacy-preserving tracking.

### SUMMARY

Embodiments described herein pertain to privacy-preserving tracking.

In various embodiments, a method for controlling an electronic device includes: accessing depth information, wherein the depth information is derived from depth data generated by a sensor of the electronic device, the sensor comprising a plurality of photodiodes and having a field-of-view within a portion of an environment surrounding the electronic device; processing the depth information to recognize a gesture performed by at least one person within the field-of-view; and performing an action based on the gesture.

In some embodiments, the sensor is configured to generate the depth data based on a phase shift between light collected by the sensor and light emitted by an illuminator of the electronic device.

In some embodiments, the illuminator comprises a plurality of vertical-cavity surface emitting lasers.

In some embodiments, processing the depth information to recognize the gesture performed by the at least one person in the environment includes using a model to detect the at least one person, wherein the model is configured based on a plurality of training examples comprising depth data.

In some embodiments, processing the depth information to recognize the gesture performed by the at least one person in the environment includes using a visual tracker to track a trajectory of the at least one person within the field-of-view, wherein the visual tracker is based on a kernelized correlation filter.

In some embodiments, performing the action based on the gesture comprises associating the gesture with an operating mode of the electronic device and controlling the electronic device based on the operating mode.

In some embodiments, the depth data is generated by the sensor by illuminating at least one object in the field-of-view with infrared light and collecting infrared light reflected by the at least one object.

In some embodiments, the sensor is a time-of-flight sensor.

In some embodiments, the method further includes capturing one or more images with the sensor.

In various embodiments, a method for tracking includes: illuminating, using an illuminator of an electronic device, an environment surrounding the electronic device with infrared light; capturing, using a sensor of the electronic device, a portion of the infrared light, the portion of the infrared light reflected from an object in a field-of-view of the sensor, wherein the sensor comprises a plurality of photodiodes; tracking a center of gravity of the object based on the portion of the infrared light; and generating a notification based on the center of gravity.

In some embodiments, the sensor is configured to generate depth data based on a phase shift between light collected by the sensor and light emitted by the illuminator.

In some embodiments, the illuminator comprises a plurality of vertical-cavity surface emitting lasers.

In some embodiments, tracking the center of gravity of the object based on the portion of the infrared light includes using a model to detect a person in the field-of-view, wherein the model is configured based on a plurality of training examples comprising depth data.

In some embodiments, tracking the center of gravity of the object based on the portion of the infrared light includes using a pose tracker to track a pose of a person in the field-of-view, wherein the pose tracker is configured to track the pose of the person based on a plurality of landmarks.

In some embodiments, generating the notification based on the center of gravity comprises determining that a change in the center of gravity of a person in the field-of-view exceeds a predetermined threshold and generating an alert indicating that the person has fallen.

In some embodiments, generating the notification based on the center of gravity comprises comparing a change in the center of gravity of a person in the field-of-view to a change in a center of gravity associated with a predetermined motion and displaying an instruction for correcting a motion of the person.

In some embodiments, the sensor is a time-of-flight sensor.

In some embodiments, the method further includes capturing one or more images with the sensor.

Some embodiments include an electronic device that includes an illuminator, a sensor comprising a plurality of photodiodes, and a processing system configured to perform part or all of the operations and/or methods disclosed herein.

Some embodiments include one or more non-transitory computer-readable media storing instructions which, when executed by a processing system, cause an electronic device to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an exemplary embodiment of an environment in which a person can be detected and tracked according to some implementations of the present disclosure.

FIG. 2 illustrates a block diagram of an embodiment of a privacy-preserving tracking system according to some implementations of the present disclosure.

FIG. 3 illustrates an exemplary arrangement of a sensing subsystem according to some implementations of the present disclosure.

FIG. 4 illustrates an exemplary embodiment of a flow for privacy-preserving tracking according to some implementations of the present disclosure.

FIG. 5 illustrates another exemplary embodiment of a flow for privacy-preserving tracking according to some implementations of the present disclosure.

FIG. 6 illustrates an example of a method for controlling an electronic device tracking according to some implementations of the present disclosure.

FIG. 7 illustrates another example of a method for tracking according to some implementations of the present disclosure.

FIG. 8 illustrates an exemplary embodiment of a smart home environment that includes various smart-home devices in which privacy-preserving tracking can be implemented according to some implementations of the present disclosure.

### DETAILED DESCRIPTION

Users have found electronic devices enabled with presence detection and motion tracking technologies to be beneficial. Some electronic devices provided with these technologies can facilitate human-computer interaction by performing gesture recognition and activity tracking. For example, a user can perform a wave or swipe gesture within a field of view of an electronic device enabled with such technologies to wake up or control the electronic device. In another example, electronic devices enabled with such technologies can track motion and assist users in performing activities such as exercising and sleeping.

Traditionally, electronic devices enabled with tracking functionality have relied on radar sensors, ultrasonic sensors, image sensors, and motion detection sensors in performing that functionality. Radar sensors can accurately determine the locations and ranges of persons within their fields of view but multi-path and/or multi-person detections are typically possible only if the targets are located at resolvable ranges and/or are moving at resolvable velocities. Additionally, radar sensors often are unable to provide scene context and resolve granular movements (e.g., detecting whether a user is looking towards or away from the electronic device). Radar sensors equipped with antennae in multiple input/multiple output arrangements are better at detecting and ranging multiple targets and resolving granular movements, but they typically come with a greater cost, power consumption, and chip size. Additionally, using radar sensors for static target detection is often undesirable due to higher latency and longer detection windows. Detection and ranging performance of ultrasonic sensors is typically similar to that of radar sensors, but, as with radar sensors, ultrasonic sensors are also typically limited in their ability to detect scene context and resolve granular movements.

Image sensors can also accurately detect and track multiple people at different ranges within their fields of view, but they typically utilize significant compute resources and do not preserve privacy. For example, images captured by an image sensor can be used to identify a person (e.g., via facial characteristics). Additionally, image sensors typically do not perform well in lower light conditions and, as a result, may lose contrast.

Motion detection sensors (e.g., accelerometers, gyroscopes, inertial measurement units, etc.) can accurately track movement, but tracking is often limited to electronic devices equipped with such sensors whenever they are worn or carried by their users. To perform tracking, these sensors often work in conjunction with other sensors such as heart rate monitors, which increases costs. Additionally, wearable or mobile electronic devices are often limited in battery capacity and frequent charging limits users' overall experience.

The features and techniques described herein overcome these challenges and/or others by providing a privacy-preserving, multi-path, and multi-person detection and tracking solution and an electronic device with a privacy-preserving depth detector and an illuminator. The depth detector can be an indirect time-of-flight sensor that includes photodiodes, and the illuminator can include vertical-cavity surface emitting lasers. A scene can be illuminated with infrared light provided by the illuminator. Infrared light reflected from objects in the scene can be collected by the indirect time-of-flight sensor. The indirect time-of-flight sensor can measure a phase shift between light emitted by the illuminator and light collected by the sensor and generate data indicative of the distances to objects in the scene. The data can be converted to depth information that can be processed to recognize gestures performed by a person in the scene and/or track the center of gravity of the person without identifying or recognizing an identity of the person. The electronic device can be controlled based on the recognized gestures and provided with a set of functionalities in which notifications can be generated based on the tracked center of gravity.

The features described herein have been described with respect to human presence detection and tracking. However, these features are not intended to be limited to humans. Rather, the features described herein can be applied to any object which can move such as animals, humanoid robots, and the like.

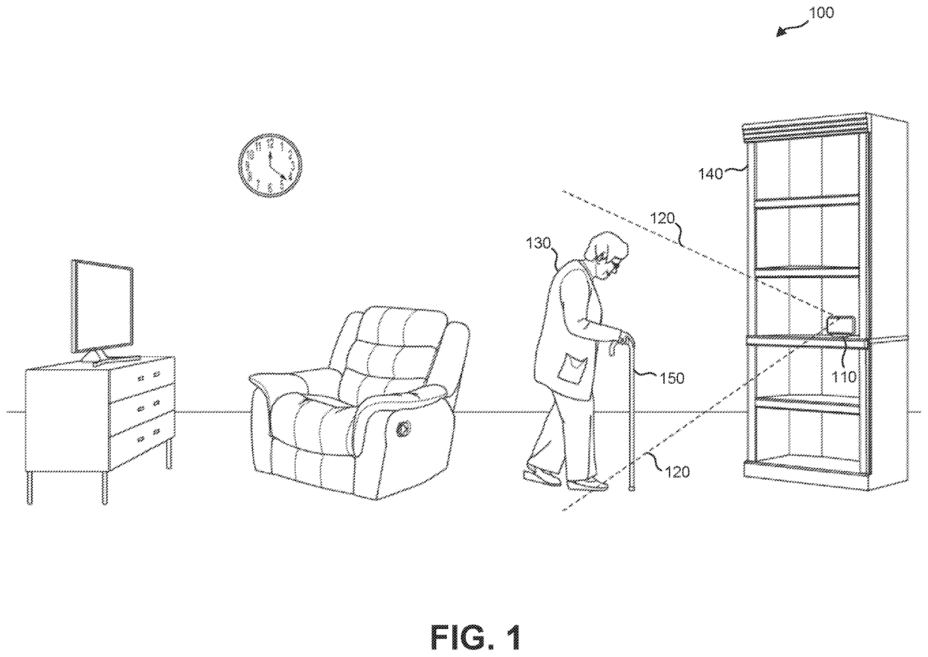

FIG. 1 illustrates an environment in which a person can be detected and tracked. As shown in FIG. 1, environment 100 may include a person 130 and an electronic device 110. In some implementations, the electronic device 110 can be an assistant device such as a Google® Nest® Hub and Google® Nest® Hub Max. In other implementations, the electronic device 110 can be a mobile phone and/or portable computing device such as a Google® Pixel® Phone and Google® Pixel® Tablet. The electronic device 110 can detect the presence of people in the environment 100 and track their movements (e.g., tracking gestures they make along other movements). For example, person 130 can move throughout the environment 100 and/or perform gestures within the environment 100 such as manipulating their walking cane 150. The electronic device 110 can be positioned in the environment 100 (e.g., on a bookshelf 140) such that a field-of-view 120 of a detector of the electronic device 110 can capture information about the environment including person 130 and other objects. The electronic device 110 can track the person's 130 movements and gestures in a privacy-preserving fashion. For example, the detector can be a depth detector that outputs information indicative of the distances that objects or portions of objects are from the electronic device 110. The electronic device 110 can then use the information to detect people in the environment and track their movements without violating their privacy (e.g., by not identifying any individual person).

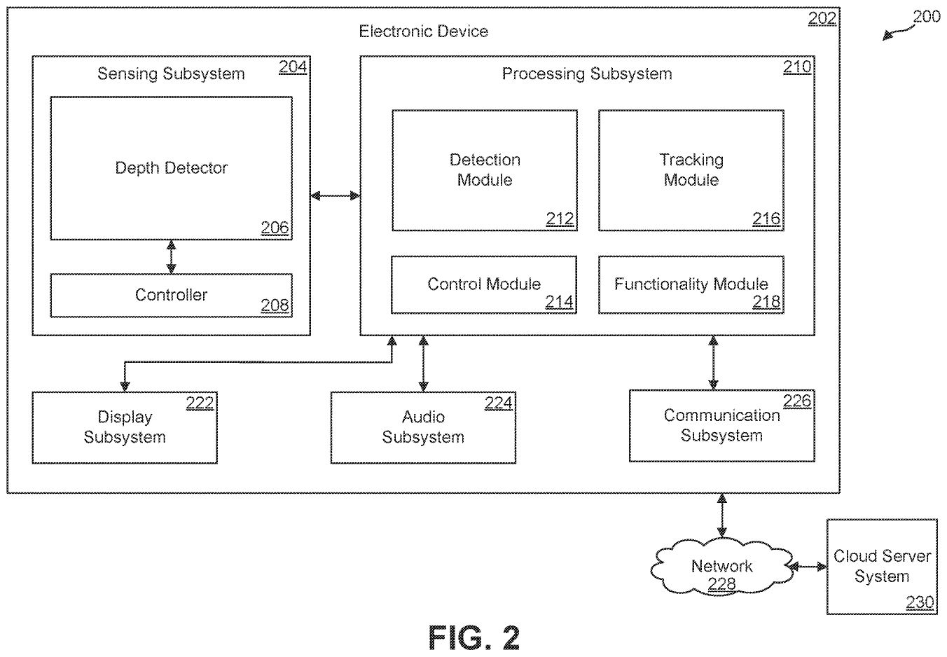

FIG. 2 illustrates a block diagram of an embodiment of a privacy-preserving tracking system 200. Privacy-preserving tracking system 200 (“system 200”) can include electronic device 202, network 228, and cloud server system 230. The electronic device 202 can include a sensing subsystem 204, a processing subsystem 210, a display subsystem 222, an audio subsystem 224, and a communication subsystem 226.

The sensing subsystem 204 can include a depth detector 206 and a controller 208. The sensing subsystem 204 can be configured to illuminate a scene, capture information about objects located within the scene, and output the information. The information can be indicative of a distance each object in the environment is from the electronic device 202, a size of each object in the environment, and a position of each object in the environment relative to the electronic device 202. For example, the sensing subsystem 204 can be configured to illuminate a scene with light such as infrared light, capture the light reflected from objects in the environment, and output information corresponding to the captured light (e.g., signals and/or data). The sensing subsystem 204 can be configured to send signals and/or data to and receive signals and/or data from processing subsystem 210. In some implementations, the processing subsystem 210 can communicate data corresponding to control signals for the controlling the sensing subsystem 204 to the controller 208 and the depth detector 206 can communicate depth data to the processing subsystem 210 for processing (e.g., converting into depth information such as depth maps, depth images, and/or point clouds).

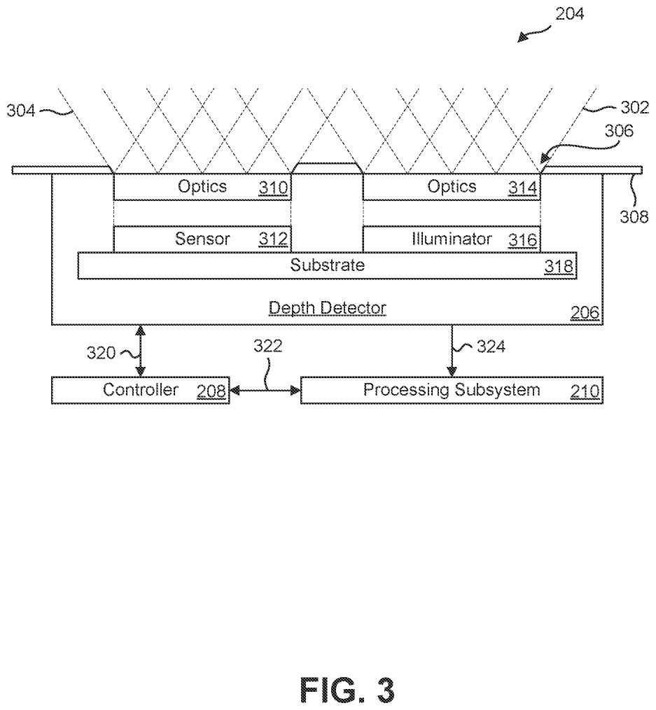

An example arrangement of the sensing subsystem 204 is shown in FIG. 3. As shown in FIG. 3, the sensing subsystem 204 can be arranged such that the depth detector 206 can have one or more fields-of-view 302, 304 through one or more openings 306 in a housing wall 308 of the electronic device 202. The depth detector 206 can include one or more substrates 318 in which a sensor 312 and an illuminator 316 can be mounted. The depth detector 206 can also include optics 310 for the sensor 312 and optics 314 for the illuminator 316.

The illuminator 316 can include vertical cavity, surface-emitting lasers (VCSELs) and/or edge-emitting lasers. In some implementations, the VCELS and/or edge-emitting lasers can be arranged in an array of rows and columns. The illuminator 316 can be configured to emit flood light, structured light, pulsed light, a combination thereof, and the like. In some implementations, the illuminator 316 can be configured to emit one or more laser beams at a particular intensity and/or duty cycle (e.g., to conform to one or more regulations and/or safety standards). The illuminator 316 can be configured to emit visible light and/or infrared light. In some implementations, each laser can be configured to emit visible and/or infrared light having a particular wavelength (e.g., 850 nanometers or 940 nanometers) and/or having a range of wavelengths.

The optics 314 for the illuminator 316 (e.g., a diffuser, diffractive optical elements) can be configured to project light (e.g., flood light, structured light, scattered light, arrayed light) from the electronic device 202 within the field-of-view 302 for the illuminator 316. The optics 314 can also include one or more filters and/or coatings that can be configured to pass and/or block light having a particular wavelength, frequency, and/or intensity and/or range of wavelengths (e.g., visible light, infrared light, a combination thereof), frequencies, and/or intensities. The optics 314 can also include one or more filters and/or coating that can be configured to block and/or reduce reflections (e.g., internal and/or external reflections). In some implementations, the optics 314 and the illuminator 316 are aligned such that the optics 314 and illuminator 316 share an optical axis.

The sensor 312 can be a complementary metal-oxide semiconductor (CMOS) sensor. The sensor 312 can include an array of pixels (e.g., pixels arranged in rows and columns). Each pixel of the sensor 312 can include one or more photodiodes, one or more sensing circuits, and one or more select circuits. The sensor 312 can be a digital sensor (e.g., a digital pixel sensor) in which signals generated by the photodiodes of the sensor 312 can be converted into digital signals. In some implementations, analog-to-digital conversion (ADC) circuitry can be included in each pixel and/or included in the sensor 312 for one or more groups of pixels. The ADC circuity can be controlled to adjust a bit depth and/or the dynamic range of the signals output from the sensor 312. The sensor 312 can be configured to be sensitive to visible and/or infrared light having a particular wavelength (e.g., 850 nanometers or 940 nanometers) and/or a range of wavelengths. For example, in some implementations, the photodiodes of the sensor 312 can be tuned to be receptive to light having a particular wavelength and/or range of wavelengths. In some other implementations, each pixel of the sensor 312 can include a tunable filter that can be configured to pass and/or block light having a particular wavelength and/or range of wavelengths. Each photodiode of the sensor 312 can be a single photon avalanche diode (SPAD) and output corresponding signals indicative of the light collected by the respective photodiodes.

In some implementations, the CMOS sensor can be configured and/or operated as an image sensor for capturing images. In this case, the signals generated by the photodiodes can be indicative of the intensity and angle of the light reflected from objects in the scene (e.g., when the sensor 312 is operating as an image sensor). The signals can be output (e.g., by the sensing subsystem 204) to the processing subsystem 210 for conversion into images such as color images, grayscale images, depth images, three-dimensional (3D) images, and the like. In some implementations, the processing subsystem 210 can convert the signals into the images at a particular frame rate (e.g., between 30-60 frames per second).

In some implementations, the CMOS sensor can be configured and/or operated as a time-of-flight (ToF) sensor (e.g., indirect ToF, direct ToF) for generating distance information. In the case of direct ToF, the signals generated by the photodiodes can be indicative of the difference between the time when light is emitted from the illuminator 316 towards the scene and the time when the light reflected from one or more objects in the scene is collected by the sensor 312. In the case of indirect ToF, the signals generated by the photodiodes can be indicative of a shift or difference between the phase of the light emitted by the illuminator 316 and the phase of the light reflected from one or more objects in the scene and collected by the sensor 312. In other implementations, the CMOS sensor 312 can be configured as a light detection and ranging (LiDAR) sensor.

The sensor 312, depth detector 206, and/or sensing subsystem 204 can include circuitry configured to calculate the distance between the depth detector 206 and one or more objects from the signals (herein referred to as “depth data”). For example, in the case of direct ToF, the circuitry can calculate the depth data based on the difference between the time when light is emitted from the illuminator 316 towards the scene and the time when the light reflected from one or more objects in the scene is collected by the sensor 312. In another example, in the case of indirect ToF, the circuitry can calculate the depth data based on the shift or difference between the phase of the light emitted by the illuminator 316 and the phase of the light reflected from one or more objects in the scene and collected by the sensor 312. The sensor 312, depth detector 206, and/or sensing subsystem 204 can output the depth data to the processing subsystem 210 for conversion into depth images, depth maps, point clouds, color images, grayscale images, and the like (herein referred to as “depth information”). The depth information is privacy-preserving in that the faces of individual people in the scene cannot be identified or recognized from the depth information. In some implementations, the sensor 312, depth detector 206, and/or sensing subsystem 2014 can output the depth data in frames and at a particular frame rate (e.g., between 30-60 frames per second). In some implementations, the processing subsystem 210 can convert the depth data into frames of depth information and at a particular frame rate (e.g., between 30-60 frames per second).

The optics 310 for the sensor 312 (e.g., microlenses, optical elements) can be configured to receive light reflected from objects with the field-of-view 304 for the sensor 312 and focus the received light on the sensor 312. The optics 310 can also include one or more filters and/or coatings that can be configured to pass and/or block light having a particular wavelength, frequency, and/or intensity and/or range of wavelengths (e.g., visible light, infrared light, a combination thereof), frequencies, and/or intensities. The optics 310 can also include one or more filters and/or coating that can be configured to block and/or reduce reflections (e.g., internal and/or external reflections). In some implementations, the optics 310 and the sensor 312 are aligned such that the optics 310 and sensor 312 share an optical axis.

The controller 208 is configured to control the illuminator 316 and the sensor 312 such that illuminator 316 can emit light and the sensor 312 can collect light synchronously. For example, the controller 208 can control the illuminator 316 to emit light towards objects within the field-of-view 302 for the illuminator 316 for a period of time and synchronously control the sensor 312 to collect light reflected by the objects within the field-of-view 304 during the period of time. Although shown as separate from the depth detector 306, the controller 320 can be included in the depth detector 306 and mounted on the substrate 318 and/or otherwise integrated with the sensor 312 and/or illuminator 316.

The processing system 302 includes one or more memories (not shown), one or more processors (not shown), and RAM (not shown). The one or more processors can read one or more programs from the one or more memories and execute them using RAM. The one or more processors can be of any type including but not limited to a microprocessor, a microcontroller, a graphical processing unit, a digital signal processor, an application-specific integrated circuit (ASIC), a field programmable gate array (FPGA), or any combination thereof. In some implementations, the one or more processors can include a plurality of cores, a plurality of arrays, one or more coprocessors, and/or one or more layers of local cache memory. The one or more processors can execute one or more programs stored in the one or more memories to perform the operations and/or methods, including parts thereof, disclosed herein.

The one or more memories can be non-volatile and can include any type of memory device that retains stored information when powered off. Non-limiting examples of memory include electrically erasable and programmable read-only memory (EEPROM), flash memory, or any other type of non-volatile memory. At least one memory of the one or more memories can include a non-transitory computer-readable storage medium from which the one or more processors can read instructions. A computer-readable storage medium can include electronic, optical, magnetic, or other storage devices capable of providing the one or more processors with computer-readable instructions or other program code. Non-limiting examples of a computer-readable storage medium include magnetic disks, memory chips, read-only memory (ROM), RAM, an ASIC, a configured processor, optical storage, or any other medium from which a computer processor can read the instructions.

The processing subsystem 210 also includes a detection module 212, a control module 214, a tracking module 216, and a functionality module 218. These components, which are presented as part of the processing subsystem 210, can be implemented as individual hardware and/or software components or may be implemented together, such as in the form of software that can be executed by the one or more processors of the processing subsystem 210.

The detection module 212 is configured to detect people in a scene (e.g., within a field-of-view of the depth detector 206), track people in the scene, and recognize gestures performed by people in the scene in a privacy-preserving fashion. As used herein, a gesture refers to a movement of a portion of a person's body (e.g., head or hand). For example, referring to FIG. 1, the detection module 212 can detect a person 130 in the environment 100, track their movements (e.g., walking towards the bookshelf 140), and recognize gestures they perform (e.g., manipulating their hand to move their walking cane 150) without identifying the person (e.g., the identity of the person detected). In another example, without identifying any person in the scene, the detection module 212 can detect that one person in a scene is performing a waving gesture with their left hand and that another person in the scene is nodding their head.

The detection module 212 is configured to detect people in the scene using an object detection model, track the detected people using a visual tracker, and recognize gestures performed by the detected people using a gesture recognition model. In some implementations, the objection detection model, visual tracker, and gesture recognition model are components of an ensemble model or open-source cross-platform machine learning framework such as MediaPipe.

To detect people in the scene, the object detection model can be configured to receive frames of depth information as an input, predict the people in the scene from the frames of depth information, and output bounding box coordinates for each predicted person. The bounding box coordinates can be 3D coordinates (e.g., x, y, z or depth) that indicate where a respective person is located in the depth information. The processing subsystem 210 can store the bounding box coordinates together with the depth information for later retrieval or processing. In some implementations, the processing subsystem 210 can generate and overlay the bounding boxes on the depth information and store the depth information overlaid with the bounding boxes. For example, in the case of a point cloud, the processing subsystem 210 can generate a 3D bounding box for each detected person, overlay the point cloud with the 3D bounding boxes at locations designated by the bounding box coordinates, and store the point cloud overlaid with the bounding boxes. The object detection model can be further configured to determine a confidence score for each predicted person. The confidence score for a predicted person can indicate a confidence level at which the object detection model predicted the respective person. The processing subsystem 210 can store the confidence scores for a predicted person together with the bounding box coordinates for the predicted person together with the depth information.

The object detection model can be any suitable trained machine learning model configured for object detection and recognition. For example, the object detection model can be a trained convolutional neural network (CNN) such as You Only Look Once version 4 (YOLOv4) or a U-Net. In some implementations, a pre-trained machine learning model can be obtained and fine-tuned to form the object detection model. The pre-trained machine learning model can be fine-tuned with labeled training data. In some implementations, the training data can include a plurality of training examples (e.g., depth maps, depth images, point clouds, and the like) with each training example depicting objects and annotated with one or more labels (e.g., bounding boxes) that identify the objects depicted by respective training example. By fine-tuning the pre-trained machine learning model with such labeled training data, the parameters of the pre-trained machine learning model can be configured to integrate depth information and/or 3D phase data.

To track the people detected by the object detection model, the visual tracker can be configured to receive the frames of depth information and bounding box coordinates generated by the object detection model, predict a movement direction or trajectory for each detected person, and output bounding box coordinates corresponding to positions along the movement direction or trajectory for each detected person. The visual tracker can be any suitable kernelized correlation filter (KCF)-based visual tracker. The bounding box coordinates can be 3D coordinates that indicate where a respective person is predicted to be along the predicted movement direction or trajectory for the respective person. The processing subsystem 210 can store the predicted bounding box coordinates for respective movement directions or trajectories together with the depth information for later retrieval or processing. In some implementations, the visual tracker can be configured to identify a primary or main subject or user from among the detected people in the scene. For example, a person whose movement direction or trajectory indicates that they are approaching the electronic device 202 can be determined by the visual tracker to be the primary user of the electronic device 202. In some implementations, the visual tracker can also be configured to determine a direction each detected person is facing. For example, a person whose movement direction or trajectory indicates that they are moving away from the electronic device 202 can be determined by the visual tracker to be turning away from a display of the electronic device 202.

To recognize gestures performed by the detected people, the gesture recognition model can be configured to receive the frames of depth information and bounding box coordinates generated by the object detection model and/or visual tracker and predict gestures performed by the detected persons. The gesture recognition model is configured to recognize gestures by identifying key points or landmarks within bounding boxes corresponding to the bounding box coordinates predicted by the object detection model and/or visual tracker, identifies hands of the detected people from the identified key points or landmarks, and predict gestures performed by the identified hands. In some implementations, the gesture recognition model is further configured to classify the type of gesture predicted by the gesture recognition model from among a predetermined set of gestures (e.g., a swiping gesture, waving gesture, a pointing gesture, and the like) the gesture recognition model is configured to classify. The processing subsystem 210 can store the classified gestures for a detected person together with the bounding box coordinates for the detected person along with the depth information for later retrieval or processing.

The gesture recognition model can be any suitable trained machine learning model configured for gesture recognition and classification such as BlazePalm and/or BlazeHand. In some implementations, a pre-trained machine learning model can be obtained and fine-tuned to form the gesture recognition model. The pre-trained machine learning model can be fine-tuned with labeled training data. In some implementations, the training data can include a plurality of training examples (e.g., depth maps, depth images, point clouds, and the like) with each training example depicting objects (e.g., hands) and annotated with one or more labels (e.g., bounding boxes) that identify the gestures performed the objects depicted by respective training example. By fine-tuning the pre-trained machine learning model with such labeled training data, the parameters of the model can be configured to recognize and classify gestures from depth information and/or 3D phase data.

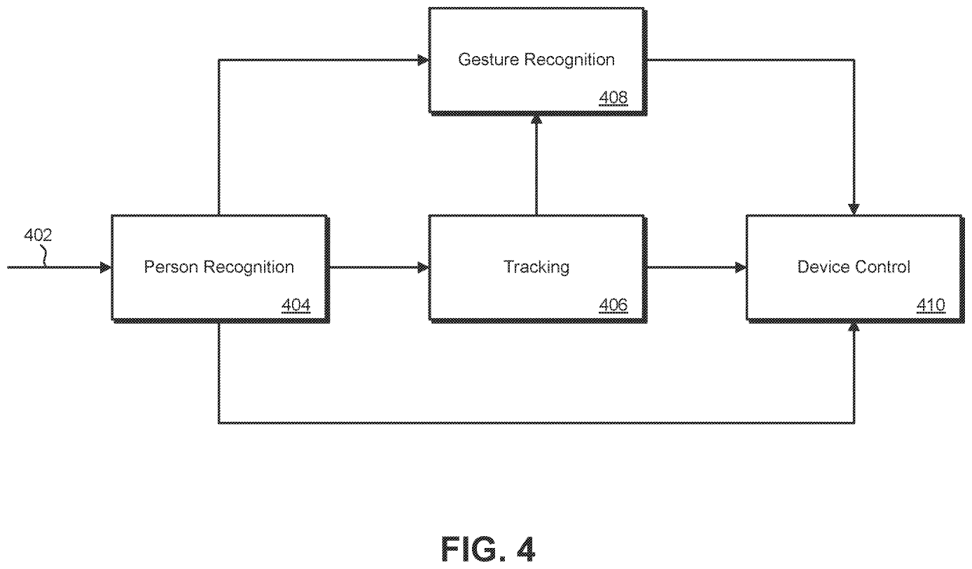

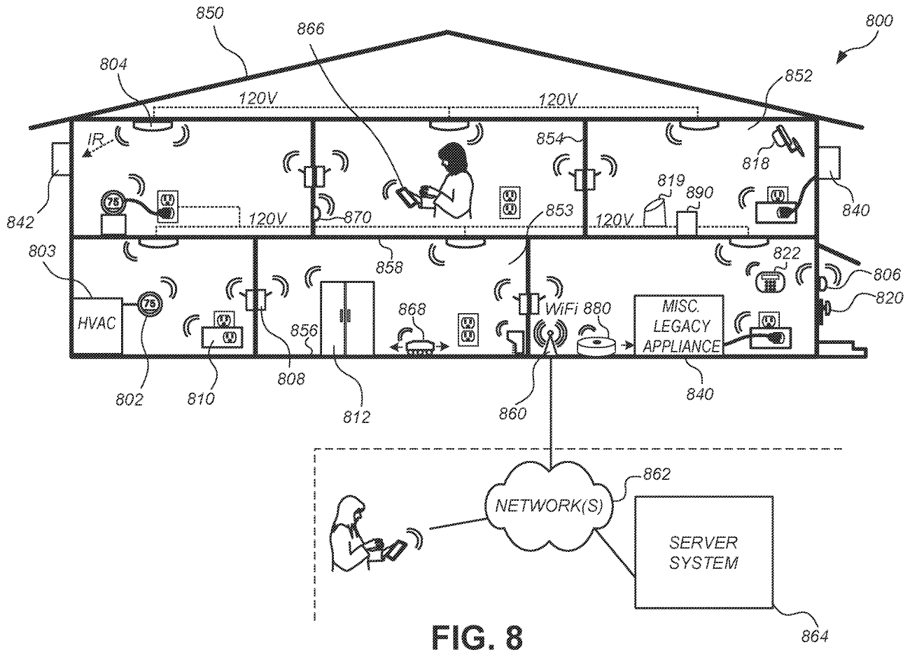

The control module 214 can be configured to cause the electronic device 202 to perform one or more actions (e.g., perform a predetermined operation and/or switch between operating modes) based on the recognitions and classifications made by the detection module 212. For example, as shown in FIG. 4, the control module 214 can cause the electronic device 202 to perform the action (at block 410): in response to a person being detected from depth information 402 by the object detection model (at block 404); in response to a detected person being tracked by the visual tracker (at block 406); and/or in response to a gesture performed by the detected person being classified by the gesture recognition model (at block 408). The control module 214 can cause the electronic device 202 to perform one or more actions based on whether a particular person is detected or whether multiple persons are detected. For example, upon detecting that multiple people have entered the scene, the control module 214 can cause the electronic device 202 to output a sound such as an alert and/or play a song. The control module 214 can also cause the electronic device 202 to perform one or more actions based on a movement direction and/or trajectory of a detected person. For example, upon detecting that a primary user of the electronic device 202 is approaching the electronic device 202, the control module 214 can cause the electronic device 202 to switch to an active or wake-up mode from an inactive or sleep mode. The control module 214 can also cause the electronic device 202 to perform one or more actions based on whether a person exhibits certain characteristics and/or performs a gesture or combination of gestures. For example, upon detecting that a person facing the electronic device 202 waves their hand, the control module 214 can cause the electronic device 202 to change content being presented on a display screen of the electronic device 202. The foregoing control of the electronic device 202 is not intended to be limiting and the electronic device 202 can be controlled in other ways in response to recognitions and classifications made by the detection module 212. In some implementations, in response to recognitions and classifications made by the detection module 212, the control module 202 can cause the electronic device 202 to control an environment in which the electronic device 202 is located. For example, in a smart home environment such as the one described with respect to FIG. 8, the electronic device 202 can cause the lights in a room in which the electronic device 202 is located, turn on an apparatus such as the HVAC system, trigger an alarm, and the like.

The tracking module 216 is configured to detect people in a scene (e.g., within the field-of-view of the depth detector 206), track poses of the detected people, and track centers of gravity for the detected people. For example, referring to FIG. 1, the tracking module 216 can detect person 130 in the environment 100, detect their pose (e.g., standing), and track their center of gravity.

The tracking module 216 is configured to detect people in the scene using a person detection model. The person detection model can be configured to receive the frames of depth information as an input, detect people in the scene from the depth information, and segment instances of people in the depth information. The person detection module can be any suitable trained machine learning model configured to detect and segment people depicted by images, depth information, and the like. In some implementations, the person detection model can be the object detection model of the detection module 212. In some implementations, the person detection model can be a trained CNN such as ShapeMask. In other implementations, a pre-trained machine learning model can be obtained and fine-tuned to form the person detection model. The person detection model can be fine-tuned with labeled training data. In some implementations, the training data can include a plurality of training examples (e.g., depth maps, depth images, point clouds, and the like) with each training example depicting people and annotated with one or more labels (e.g., bounding boxes) that identify the people depicted by respective training example. By fine-tuning the pre-trained machine learning model with such labeled training data, the parameters of the model can be configured to integrate depth information and/or 3D phase data.

The tracking module 216 is configured to track poses of the people detected by the person detection model using a pose tracking model. The pose tracking model is configured to receive frames of the segmented depth information from the person detection model, generate a 3D skeletal wire representation for each detected person, and track the 3D skeletal wire representations. The 3D skeletal wire representation for each detected person can include a number of 3D landmarks (e.g., a 3D landmark at each of the person's joints). The pose tracking model can be any suitable trained machine learning model (e.g., a neural network) that is configured to detect and track poses. In some implementations, the pose tracking model person detection model can be the BlazePose model extended to 3D. For example, the BlazePose model can be extended to detect additional landmarks (e.g., detect 40 3D landmarks).

The tracking module 216 is configured to track centers of gravity of the tracked poses. The tracking module 216 can be configured to track centers of gravity of tracked poses by extending the 3D skeletal wire representations to 3D volumetric representations, calculating a center of gravity for each detected person from the 3D volumetric representations, and tracking the calculated centers of gravity. The 3D skeletal wire representations can be extended 3D volumetric representations by extending the points of 3D skeletal wire representations in a depth direction and calculating a volume for each detected person based on the extended points of the 3D skeletal wire representations.

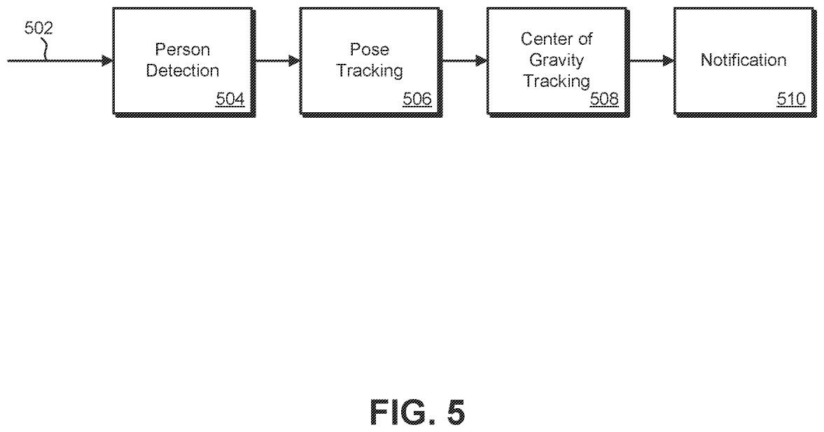

The functionality module 218 can be configured to provide the electronic device 202 with a set of functionalities. For each functionality, as shown in FIG. 5: at block 504, a person can be detected from depth information 502; at block 506, a pose of the person can be detected and tracked; at block 508, a center of gravity of the person can be tracked; and, at block 510, a notification can be generated based on the tracked center of gravity. The set of functionalities can include a fall detection functionality, exercise tracking functionality, posture checking functionality, and sleep tracking functionality. The fall detection functionality can be configured to track a user's center of gravity and detect when the user is falling and/or has fallen based on the person's center of gravity. In some implementations, a notification such as an alert can be generated when the functionality module 218 detects that a person is falling and/or has fallen. The fall detection functionality can be configured to detect that the person is falling and/or has fallen when changes in the person's center of gravity exceed a predetermined threshold. For example, the fall detection functionality can be configured track a user's center of gravity for a predetermined number of frames and/or for a predetermined period of time and detect that the person is falling and/or has fallen when changes in the person's center of gravity exceed the predetermined threshold within the predetermined number of frames and/or the predetermined period of time. The alert can be audible alert and/or inaudible alert. For example, in a smart home environment such as the one described with respect to FIG. 8, when the electronic device 202 detects that a user is falling and/or has fallen, the electronic device 202 can generate a notification and distribute the notification to smart devices in the smart home environment and/or to entities or users (e.g., emergency contacts) within/outside of the smart home environment.

The exercise tracking functionality can be configured to track a person's center of gravity, detect what motion the person is performing based on changes in the person's center of gravity and the 3D landmarks of the 3D skeletal wire representation for the person, determine a rate which the person is performing those motions, and compare the motions performed by the person to a list of predetermined motions to associate the person's motion with a type of exercise. In some implementations, when a type of exercise has been identified, the functionality module 218 can compare the person's motions to a reference motion associated with the type of exercise and generate a notification when the person's motion does not match the reference motion. The notification can be displayed on a display of the electronic device 202 and provide instructions to the user for correcting their exercise form.

The posture checking functionality can be configured to track a person's center of gravity and detect that the person is slouching, leaning, and/or otherwise has poor posture based on changes in the person's center of gravity exceeding a first threshold but being less than a second threshold. As with the fall detection functionality, an alert can be generated when the functionality module 218 detects that a person is slouching, leaning, and/or otherwise has poor posture.

The sleep tracking functionality can be configured to track a person's center of gravity, detect that the person is laying down, and detect what motions the person is exhibiting and/or performing while the person is lying down based on changes in the person's center of gravity. For example, when the person is lying down between 10 PM and 6 AM, a notification can be generated when changes in the person's motion above a predetermined threshold are detected. In some implementations, the notification can include generating an entry for insertion in a sleep record of the person. In some implementations, in addition to, or alternative to, tracking a person's center of gravity, the sleep tracking functionality can be configured to track the person's breathing and/or heart rate. In this way, motions the person is exhibiting and/or performing while the person is lying down can be further refined based the person's breathing and/or heart rate. The person's breathing and/or heart rate can be calculated based on images, radar signals, and/or ultrasonic signals. In some implementations, image data received from the sensor 312, radar signals received from a radar sensor, and/or ultrasonic signals received from an ultrasonic sensor can be combined using one or more filters such as a Kalman filter and/or particle filter and the sleep tracking functionality can further refine any detected motions the person is exhibiting and/or performing based on the combined signals. For example, once motion is detected based on center of gravity tracking, the motion detection can be refined by comparing the combined signals to one or more predetermined motion detection thresholds.

The foregoing functionalities are not intended to be limiting and the electronic device 202 can include additional functionalities that is enabled by tracking centers of gravity of persons in a scene and/or environment.

The electronic device 202 also includes a display subsystem 222 that can be configured to display depth maps, point clouds, color images, grayscale images, video, and other content on a display screen of the electronic device 202 and receive input from a user of the electronic device 202. Examples of the display screen included in the display subsystem 222 include a liquid crystal display, a light emitting diode display, an organic light emitting diode display, a projector display, a touchscreen display, and the like.

The electronic device 202 also includes an audio subsystem 224 that can be configured to record sounds from the environment surrounding the electronic device 202 and output sounds to the environment surrounding the electronic device 202. Examples of audio devices included in audio subsystem 224 include microphones, speakers, and other audio/sound transducers for receiving and outputting audio signals and other sounds.

The electronic device 202 also includes a communications subsystem 226 that can be configured to enable the electronic device 202 to communicate with various wired or wireless networks and other systems and devices. For example, communications subsystem 226 can enable the electronic device 202 to communicate with network 228. Network 228 can include one or more private and/or public networks, such as the Internet. Network 228 can be used such that electronic device 202 can communicate with the cloud server system 230. Cloud server system 230 can, in some implementations, perform some of the processing functions performed by processing subsystem 210. Additionally, or alternatively, cloud server system 230 can be used to relay notifications and/or store data generated electronic device 230. For instance, in association with the user account, alerts and/or notifications generated by electronic device 202 can be logged by cloud server system 230. Examples of communications devices included in communications subsystem 226 include wireless communication modules and chips, wired communication modules and chips, chips for communicating over local area networks, wide area networks, cellular networks, satellite networks, fiber optic networks, and the like, systems on chips, and other circuitry that enables the electronic device 202 to send and receive data.

Although not shown, the electronic device 202 can also include other components that provide the electronic device 202 with various functionality. Other components can include storage devices, power generating/storing devices, input/output (I/O) components, and the like. The foregoing configurations of the electronic device 202 are not intended to be limiting and the electronic device 202 can include other subsystems, devices, and components.

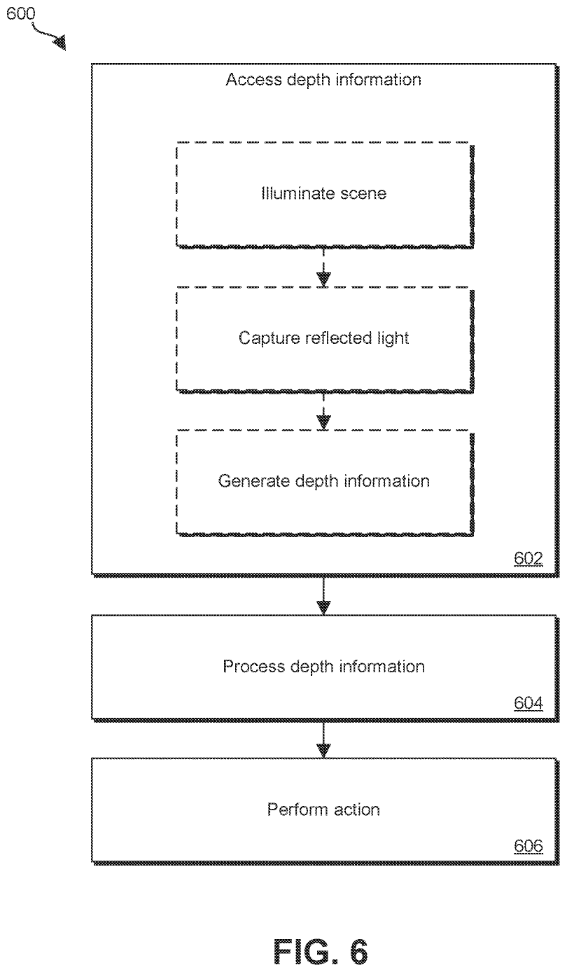

FIG. 6 illustrates a method 600 for controlling an electronic device. The processing depicted in FIG. 6 may be implemented in software (e.g., code, instructions, program) executed by a processing system such as processing subsystem 210 of the electronic device 202. The software may be stored on a non-transitory computer-readable storage medium (e.g., a memory device). The method 600 is intended to be illustrative and non-limiting. For example, although FIG. 6 depicts the various processing steps occurring in a particular sequence or order, in other embodiments, the steps may be performed in some different order or some steps may also be performed in parallel.

At block 602, depth information is accessed. In some implementations, the depth information can be accessed from a storage medium. The depth information can be derived from depth data generated by a sensor of the electronic device. In some implementations, the sensor can be a time-of-flight sensor. The sensor can have a field-of-view within a portion of an environment surrounding the electronic device. The field-of-view can include at least one object. The depth information can be generated by the sensor based on a phase shift between light captured or collected by the sensor and light emitted by an illuminator of the electronic device. The illuminator can illuminate an environment surrounding the electronic device, including the at least one object in the field-of-view, with infrared red. The sensor can capture or collect a portion of the infrared light, the portion of the infrared light being reflected from the at least one object in the field-of-view of the time-of-flight sensor. The illuminator can include a plurality of vertical-cavity surface emitting lasers. In some implementations, the depth information can be stored in a storage medium and accessed by the processing system for further processing. In some other implementations, the sensor can be configured as an image sensor and capture color images, grayscale images, depth images, three-dimensional (3D) images, and the like, in response to visible and/or infrared reflected from one or more objects in the scene.

At block 604, the depth information is processed to recognize a gesture performed by at least one person within the field-of-view. The depth information can be processed by using a model to detect the at least one person and using a visual tracker to track a trajectory of the at least one person within the field-of-view. The model can be configured based on training examples comprising depth data and the visual tracker is based on a kernelized correlation filter.

At block 606, an action is performed based on the gesture. The action can be performed based on the gesture by associating the gesture with an operating mode of the electronic device and controlling the electronic device based on the operating mode.

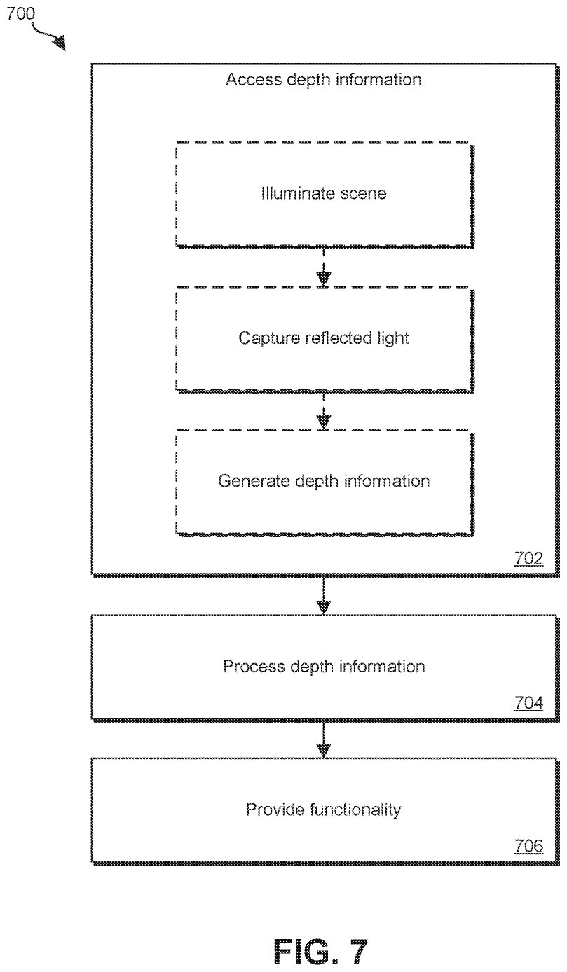

FIG. 7 illustrates a method 700 for tracking. The processing depicted in FIG. 7 may be implemented in software (e.g., code, instructions, program) executed by a processing system such as processing subsystem 210 of the electronic device 202. The software may be stored on a non-transitory computer-readable storage medium (e.g., a memory device). The method 700 is intended to be illustrative and non-limiting. For example, although FIG. 7 depicts the various processing steps occurring in a particular sequence or order, in other embodiments, the steps may be performed in some different order or some steps may also be performed in parallel.

At block 702, depth information is accessed. In some implementations, the depth information can be accessed from a storage medium. The depth information can be derived from depth data generated by a sensor of the electronic device. In some implementations, the sensor can be a time-of-flight sensor. The sensor can have a field-of-view within a portion of an environment surrounding the electronic device. The field-of-view can include at least one object. The depth information can be generated by the sensor based on a phase shift between light captured or collected by the sensor and light emitted by an illuminator of the electronic device. The illuminator can illuminate an environment surrounding the electronic device, including the at least one object in the field-of-view, with infrared red. The sensor can capture or collect a portion of the infrared light, the portion of the infrared light being reflected from the at least one object in the field-of-view of the time-of-flight sensor. The illuminator can include a plurality of vertical-cavity surface emitting lasers. In some implementations, the depth information can be stored in a storage medium and accessed by processing system for further processing. In some other implementations, the sensor can be configured as an image sensor and capture color images, grayscale images, depth images, three-dimensional (3D) images, and the like, in response to visible and/or infrared reflected from one or more objects in the scene.

At block 704, a center of gravity of the object is tracked. The center of gravity of the object is tracked by using a model to detect a person in the field-of-view from the depth information and using a pose tracker to track a pose of the person in the field-of-view. The model can be configured based on training examples comprising depth data and the pose tracker can be configured to track the pose of the person based on a plurality of landmarks.

At block 706, a notification is generated. The notification can be generated based on the center of gravity by determining that a change in the center of gravity of a person in the field-of-view exceeds a predetermined threshold and generating an alert indicating that the person has fallen. The notification can also be generated based on the center of gravity by comparing a change in the center of gravity of a person in the field-of-view to a change in a center of gravity associated with a predetermined motion and displaying an instruction for correcting a motion of the person.

FIG. 8 illustrates an embodiment of a smart home environment 800 in which various smart-home devices may include the componentry of electronic device 110/202 to detect people and track their movements in a privacy-preserving fashion. For example, in some implementations, the smart-home devices can include the sensing subsystem 204 and/or processing subsystem 210 of the electronic device 202. In another example, in some implementations, the smart-home devices can include one or more of the detection module 212, control module 214, tracking module 216, and functionality module 218. Various smart-home devices, including those located indoors or outdoors, may benefit from the ability to detect people and track their movements.

The smart home environment 800 includes a structure 850 (e.g., a house, daycare, office building, apartment, condominium, garage, or mobile home) with various integrated devices. It will be appreciated that devices may also be integrated into a smart home environment 800 that does not include an entire structure 850, such as an apartment or condominium. Further, the smart home environment 800 may control and/or be coupled to devices outside of the actual structure 850. Indeed, several devices in the smart home environment 800 need not be physically within the structure 850.

It is to be appreciated that “smart home environments” may refer to smart environments for homes such as a single-family house, but the scope of the present teachings is not so limited. The present teachings are also applicable, without limitation, to duplexes, townhomes, multi-unit apartment buildings, hotels, retail stores, office buildings, industrial buildings, and more generally any living space or workspace.

It is also to be appreciated that while the terms user, customer, installer, homeowner, occupant, guest, tenant, landlord, repair person, and the like may be used to refer to the person or persons acting in the context of some particular situations described herein, these references do not limit the scope of the present teachings with respect to the person or persons who are performing such actions. Thus, for example, the terms user, customer, purchaser, installer, subscriber, and homeowner may often refer to the same person in the case of a single-family residential dwelling, because the head of the household is often the person who makes the purchasing decision, buys the unit, and installs and configures the unit, and is also one of the users of the unit. However, in other scenarios, such as a landlord-tenant environment, the customer may be the landlord with respect to purchasing the unit, the installer may be a local apartment supervisor, a first user may be the tenant, and a second user may again be the landlord with respect to remote control functionality. Importantly, while the identity of the person performing the action may be germane to a particular advantage provided by one or more of the implementations, such identity should not be construed in the descriptions that follow as necessarily limiting the scope of the present teachings to those particular individuals having those particular identities.

The depicted structure 850 includes a plurality of rooms 852, separated at least partly from each other via walls 854. The walls 854 may include interior walls or exterior walls. Each room may further include a floor 856 and a ceiling 858. Devices may be mounted on, integrated with and/or supported by a wall 854, floor 856, or ceiling 858.

In some implementations, the integrated devices of the smart home environment 800 include intelligent, multi-sensing, network-connected devices that integrate seamlessly with each other in a smart home network and/or with a central server or a cloud-computing system to provide a variety of useful smart home functions. The smart home environment 800 may include one or more intelligent, multi-sensing, network-connected thermostats 802 (hereinafter referred to as “smart thermostats 802”), one or more intelligent, network-connected, multi-sensing hazard detection units 804 (hereinafter referred to as “smart hazard detectors 804”), one or more intelligent, multi-sensing, network-connected entryway interface devices 806 and 820 and one or more intelligent, multi-sensing, network-connected alarm systems 822 (hereinafter referred to as “smart alarm systems 822”). Each of these devices may have the functionality of electronic device 110/202 incorporated.

In some implementations, the one or more smart thermostats 802 detect ambient climate characteristics (e.g., temperature and/or humidity) and control an HVAC system 803 accordingly. For example, a respective smart thermostat 802 includes an ambient temperature sensor.

A smart hazard detector may detect smoke, carbon monoxide, and/or some other hazard present in the environment. The one or more smart hazard detectors 804 may include thermal radiation sensors directed at respective heat sources (e.g., a stove, oven, other appliances, a fireplace, etc.). For example, a smart hazard detector 804 in a kitchen 853 includes a thermal radiation sensor directed at a network-connected appliance 812. A thermal radiation sensor may determine the temperature of the respective heat source (or a portion thereof) at which it is directed and may provide corresponding black-body radiation data as output.

The smart doorbell 806 and/or the smart door lock 820 may detect a person's approach to or departure from a location (e.g., an outer door), control doorbell/door locking functionality (e.g., receive user inputs from a portable electronic device 866 to actuate the bolt of the smart door lock 820), announce a person's approach or departure via audio or visual means, and/or control settings on a security system (e.g., to activate or deactivate the security system when occupants go and come). In some implementations, the smart doorbell 806 includes a camera, and, therefore, is also called “doorbell camera 806” in this document.

The smart alarm system 822 may detect the presence of an individual within close proximity (e.g., using built-in IR sensors), sound an alarm (e.g., through a built-in speaker, or by sending commands to one or more external speakers), and send notifications to entities or users within/outside of the smart home environment 800. In some implementations, the smart alarm system 822 also includes one or more input devices or sensors (e.g., keypad, biometric scanner, NFC transceiver, microphone) for verifying the identity of a user, and one or more output devices (e.g., display, speaker). In some implementations, the smart alarm system 822 may also be set to an armed mode, such that detection of a trigger condition or event causes the alarm to be sounded unless a disarming action is performed. Each of these devices may have the functionality of electronic device 110/202 incorporated.

In some implementations, the smart home environment 800 includes one or more intelligent, multi-sensing, network-connected wall switches 808 (hereinafter referred to as “smart wall switches 808”), along with one or more intelligent, multi-sensing, network-connected wall plug interfaces 810 (hereinafter referred to as “smart wall plugs 810”). The smart wall switches 808 may detect ambient lighting conditions, detect room-occupancy states, and control a power and/or dim state of one or more lights. In some instances, smart wall switches 808 may also control a power state or speed of a fan, such as a ceiling fan. The smart wall plugs 810 may detect occupancy of a room or enclosure and control the supply of power to one or more wall plugs (e.g., such that power is not supplied to the plug if nobody is at home). Each of these types of devices may have the functionality of electronic device 110/202 incorporated.

In some implementations, the smart home environment 800 of FIG. 8 includes a plurality of intelligent, multi-sensing, network-connected appliances 812 (hereinafter referred to as “smart appliances 812”), such as refrigerators, stoves, ovens, televisions, washers, dryers, lights, stereos, intercom systems, wall clock, garage-door openers, floor fans, ceiling fans, wall air conditioners, pool heaters, irrigation systems, security systems, space heaters, window AC units, motorized duct vents, and so forth. Each of these devices may have the functionality of electronic device 110/202 incorporated. In some implementations, when plugged in, an appliance may announce itself to the smart home network, such as by indicating what type of appliance it is, and it may automatically integrate with the controls of the smart home. Such communication by the appliance to the smart home may be facilitated by either a wired or wireless communication protocol. The smart home may also include a variety of non-communicating legacy appliances 840, such as old conventional washer/dryers, refrigerators, and the like, which may be controlled by smart wall plugs 810. The smart home environment 800 may further include a variety of partially communicating legacy appliances 842, such as infrared (“IR”) controlled wall air conditioners or other IR-controlled devices, which may be controlled by IR signals provided by the smart hazard detectors 804 or the smart wall switches 808.

In some implementations, the smart home environment 800 includes one or more network-connected cameras 818 that are configured to provide video monitoring and security in the smart home environment 800. Cameras 818 may be mounted in a location, such as indoors and to a wall or can be moveable and placed on a surface. Various embodiments of cameras 818 may be installed indoors or outdoors. Each of these types of devices may have the functionality of electronic device 110/202 incorporated. Cameras 818 may be used to determine occupancy of the structure 850 and/or particular rooms 852 in the structure 850, and thus may act as occupancy sensors. For example, video captured by the cameras 818 may be processed to identify the presence of an occupant in the structure 850 (e.g., in a particular room 852). Specific individuals may be identified based, for example, on their appearance (e.g., height, face) and/or movement (e.g., their walk/gait). Cameras 818 may additionally include one or more sensors (e.g., IR sensors, motion detectors), input devices (e.g., microphone for capturing audio), and output devices (e.g., speaker for outputting audio). In some implementations, the cameras 818 are each configured to operate in a day mode and in a low-light mode (e.g., a night mode). In some implementations, the cameras 818 each include one or more IR illuminators for providing illumination while the camera is operating in the low-light mode. In some implementations, the cameras 818 include one or more outdoor cameras. In some implementations, the outdoor cameras include additional features and/or components such as weatherproofing and/or solar ray compensation.

The smart home environment 800 may additionally or alternatively include one or more other occupancy sensors (e.g., the smart doorbell 806, smart door locks 820, touch screens, IR sensors, microphones, ambient light sensors, motion detectors, smart nightlights 370, etc.). In some implementations, the smart home environment 800 includes radio-frequency identification (RFID) readers (e.g., in each room 852 or a portion thereof) that determine occupancy based on RFID tags located on or embedded in occupants. For example, RFID readers may be integrated into the smart hazard detectors 804.

Smart home assistant 819 may have one or more microphones that continuously listen to an ambient environment. Smart home assistant 819 may be able to respond to verbal queries posed by a user, possibly preceded by a triggering phrase. Smart home assistant 819 may stream audio and, possibly, video if a camera is integrated as part of the device, to a cloud-based server system 864 (which represents an embodiment of cloud server system 230 of FIG. 2). Smart home assistant 819 may be a smart device through which non-auditory discomfort alerts may be output and/or an audio stream from the streaming video camera can be output. As previously noted, smart home assistant 819 may have the functionality of electronic device 110/202 incorporated.

By virtue of network connectivity, one or more of the smart-home devices may further allow a user to interact with the device even if the user is not proximate to the device. For example, a user may communicate with a device using a computer (e.g., a desktop computer, laptop computer, or tablet) or another portable electronic device 866 (e.g., a mobile phone, such as a smart phone). A webpage or application may be configured to receive communications from the user and control the device based on the communications and/or to present information about the device's operation to the user. For example, the user may view a current set point temperature for a device (e.g., a stove) and adjust it using a computer. The user may be in the structure during this remote communication or outside the structure.

As discussed above, users may control smart devices in the smart home environment 800 using a network-connected computer or portable electronic device 866. In some examples, some or all of the occupants (e.g., individuals who live in the home) may register their portable electronic device 866 with the smart home environment 800. Such registration may be made at a central server to authenticate the occupant and/or the device as being associated with the home and to give permission to the occupant to use the device to control the smart devices in the home. An occupant may use their registered portable electronic device 866 to remotely control the smart devices of the home, such as when the occupant is at work or on vacation. The occupant may also use their registered device to control the smart devices when the occupant is actually located inside the home, such as when the occupant is sitting on a couch inside the home. It should be appreciated that instead of or in addition to registering portable electronic devices 866, the smart home environment 800 may make inferences about which individuals live in the home and are therefore occupants and which portable electronic devices 866 are associated with those individuals. As such, the smart home environment may “learn” who is an occupant and permit the portable electronic devices 866 associated with those individuals to control the smart devices of the home.

In some implementations, in addition to containing processing and sensing capabilities, smart thermostat 802, smart hazard detector 804, smart doorbell 806, smart wall switch 808, smart wall plug 810, network-connected appliances 812, cameras 818, smart home assistant 819, smart door lock 820, and/or smart alarm system 822 (collectively referred to as “the smart-home devices”) are capable of data communications and information sharing with other smart devices, a central server or cloud-computing system, and/or other devices that are network-connected. Data communications may be carried out using any of a variety of custom or standard wireless protocols (e.g., IEEE 802.15.4, Wi-Fi, ZigBee, 3LoWPAN, Thread, Z-Wave, Bluetooth Smart, ISA 100.5A, WirelessHART, MiWi, etc.) and/or any of a variety of custom or standard wired protocols (e.g., Ethernet, HomePlug, etc.), or any other suitable communication protocol, including communication protocols not yet developed as of the filing date of this document.

In some implementations, the smart devices serve as wireless or wired repeaters. In some implementations, a first one of the smart devices communicates with a second one of the smart devices via a wireless router. The smart devices may further communicate with each other via a connection (e.g., network interface 860) to a network, such as the Internet. Through the Internet, the smart devices may communicate with a cloud-based server system 864 (also called a cloud-based server system, central server system, and/or a cloud-computing system herein). Cloud-based server system 864 may be associated with a manufacturer, support entity, or service provider associated with the smart device(s). In some implementations, a user is able to contact customer support using a smart device itself rather than needing to use other communication means, such as a telephone or Internet-connected computer. In some implementations, software updates are automatically sent from cloud-based server system 864 to smart devices (e.g., when available, when purchased, or at routine intervals).

In some implementations, the network interface 860 includes a conventional network device (e.g., a router), and the smart home environment 800 of FIG. 8 includes a hub device 880 that is communicatively coupled to the network(s) 862 directly or via the network interface 860. The hub device 880 is further communicatively coupled to one or more of the above intelligent, multi-sensing, network-connected devices (e.g., smart devices of the smart home environment 800). Each of these smart devices optionally communicates with the hub device 880 using one or more radio communication networks available at least in the smart home environment 800 (e.g., ZigBee, Z-Wave, Insteon, Bluetooth, Wi-Fi and other radio communication networks). In some implementations, the hub device 880 and devices coupled with/to the hub device can be controlled and/or interacted with via an application running on a smart phone, household controller, laptop, tablet computer, game console or similar electronic device. In some implementations, a user of such a controller application can view the status of the hub device or coupled smart devices, configure the hub device to interoperate with smart devices newly introduced to the home network, commission new smart devices, and adjust or view settings of connected smart devices, etc. In some implementations the hub device extends capabilities of low capability smart devices to match capabilities of the highly capable smart devices of the same type, integrates functionality of multiple different device types—even across different communication protocols—and is configured to streamline adding of new devices and commissioning of the hub device. In some implementations, hub device 880 further includes a local storage device for storing data related to, or output by, smart devices of smart home environment 800. In some implementations, the data includes one or more of: video data output by a camera device, metadata output by a smart device, settings information for a smart device, usage logs for a smart device, and the like.

In some implementations, smart home environment 800 includes a local storage device 890 for storing data related to, or output by, smart devices of smart home environment 800. In some implementations, the data includes one or more of: video data output by a camera device (e.g., cameras 818 or smart doorbell 806), metadata output by a smart device, settings information for a smart device, usage logs for a smart device, and the like. In some implementations, local storage device 890 is communicatively coupled to one or more smart devices via a smart home network. In some implementations, local storage device 890 is selectively coupled to one or more smart devices via a wired and/or wireless communication network. In some implementations, local storage device 890 is used to store video data when external network conditions are poor. For example, local storage device 890 is used when an encoding bitrate of cameras 818 exceeds the available bandwidth of the external network (e.g., network(s) 862). In some implementations, local storage device 890 temporarily stores video data from one or more cameras (e.g., cameras 818) prior to transferring the video data to a server system (e.g., cloud-based server system 864).

Further included and illustrated in the exemplary smart home environment 800 of FIG. 8 are service robots 868, each configured to carry out, in an autonomous manner, any of a variety of household tasks. For some embodiments, the service robots 868 can be respectively configured to perform floor sweeping, floor washing, etc.

In some embodiments, a service robot may follow a person from room to room and position itself such that the person can be monitored while in the room. The service robot may stop in a location within the room where it will likely be out of the way, but still has a relatively clear field-of-view of the room. Service robots 868 may have the functionality of electronic device 110/202 incorporated therein. Such an arrangement may have the advantage of allowing one service robot with the functionality of electronic device 110/202 incorporated to detect and track a person throughout multiple rooms or in a large space.

The systems and methods of the present disclosure may be implemented using hardware, software, firmware, or a combination thereof and may be implemented in one or more computer systems or other processing systems. Some embodiments of the present disclosure include a system and/or electronic including a processing system that includes one or more processors. In some embodiments, the system includes one or more non-transitory computer readable storage media containing instructions which, when executed on the one or more processors, cause the system and/or the one or more processors and/or electronic device to perform part or all of one or more methods and/or part or all of one or more processes disclosed herein. Some embodiments of the present disclosure include a computer-program product tangibly embodied in a non-transitory machine-readable storage medium, including instructions configured to cause the system and/or the one or more processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

1. A method for controlling an electronic device, the method comprising:
accessing depth information, wherein the depth information is derived from depth data generated by a sensor of the electronic device, the sensor comprising a plurality of photodiodes and having a field-of-view within a portion of an environment surrounding the electronic device;
processing the depth information to recognize a gesture performed by at least one person within the field-of-view; and
performing an action based on the gesture.

2. The method of claim 1, wherein the sensor is configured to generate the depth data based on a phase shift between light collected by the sensor and light emitted by an illuminator of the electronic device.

3. The method of claim 2, wherein the illuminator comprises a plurality of vertical-cavity surface emitting lasers.

4. The method of claim 1, wherein processing the depth information to recognize the gesture performed by the at least one person in the environment comprises:
using a model to detect the at least one person, wherein the model is configured based on a plurality of training examples comprising depth data.

5. The method of claim 1, wherein processing the depth information to recognize the gesture performed by the at least one person in the environment comprises:
using a visual tracker to track a trajectory of the at least one person within the field-of-view, wherein the visual tracker is based on a kernelized correlation filter.

6. The method of claim 1, wherein performing the action based on the gesture comprises associating the gesture with an operating mode of the electronic device and controlling the electronic device based on the operating mode.

7. The method of claim 1, wherein the depth data is generated by the sensor by illuminating at least one object in the field-of-view with infrared light and collecting infrared light reflected by the at least one object.

8. The method of claim 1, wherein the sensor is a time-of-flight sensor.

9. The method of claim 1, further comprising:
capturing one or more images with the sensor.

10. An electronic device comprising:
an illuminator;
a sensor comprising a plurality of photodiodes;
and a processing system configured:
access depth information, wherein the depth information is derived from depth data generated by the sensor, the sensor having a field-of-view within a portion of an environment surrounding the electronic device;
processing the depth information to recognize a gesture performed by at least one person within the field-of-view; and
performing an action based on the gesture.

11. The electronic device of claim 10, wherein the sensor is configured to generate the depth data based on a phase shift between light collected by the sensor and light emitted by an illuminator of the electronic device.

12.-27. (canceled)

28. A method for tracking, the method comprising:
illuminating, using an illuminator of an electronic device, an environment surrounding the electronic device with infrared light;
capturing, using a sensor of the electronic device, a portion of the infrared light, the portion of the infrared light reflected from an object in a field-of-view of the sensor, wherein the sensor comprises a plurality of photodiodes;
tracking a center of gravity of the object based on the portion of the infrared light;
and generating a notification based on the center of gravity.

29. The method of claim 28, wherein the sensor is configured to generate depth data based on a phase shift between light collected by the sensor and light emitted by the illuminator.

30. The method of claim 28, wherein the illuminator comprises a plurality of vertical-cavity surface emitting lasers.

31. The method of claim 28, wherein tracking the center of gravity of the object based on the portion of the infrared light comprises:
using a model to detect a person in the field-of-view, wherein the model is configured based on a plurality of training examples comprising depth data.

32. The method of claim 28, wherein tracking the center of gravity of the object based on the portion of the infrared light comprises:
using a pose tracker to track a pose of a person in the field-of-view, wherein the pose tracker is configured to track the pose of the person based on a plurality of landmarks.

33. The method of claim 28, wherein generating the notification based on the center of gravity comprises determining that a change in the center of gravity of a person in the field-of-view exceeds a predetermined threshold and generating an alert indicating that the person has fallen.

34. The method of claim 28, wherein generating the notification based on the center of gravity comprises comparing a change in the center of gravity of a person in the field-of-view to a change in a center of gravity associated with a predetermined motion and displaying an instruction for correcting a motion of the person.

35. The method of claim 28, wherein the sensor is a time-of-flight sensor.

36. The method of claim 28, further comprising:
capturing one or more images with the sensor.

37.-53. (canceled)
